(19) United States
(12) Patent Application Publication
(10) Pub. No.: US 2026/0071592 A1
(43) Pub. Date: Mar. 12, 2026

(54) JOINT FOR MOUNTING COMPONENTS ON A ROCKET

(71) Applicant: Blue Origin, LLC, Kent, WA (US)

(72) Inventors: Daniel Kent Vetters, Maple Valley, WA (US); Bartley Lettenberger, Issaquah, WA (US)

(21) Appl. No.: 18/882,515

(22) Filed: Sep. 11, 2024

(51) Int. Cl. F02K 9/34; F16B 39/24

(52) U.S. Cl. CPC F02K 9/343; F16B 39/24

(57) ABSTRACT

A joint for mounting a component on a rocket, such as mounting a valve to a rocket body. The joint comprises a coiled roll pin and a shaft. The coiled roll pin comprises a rolled sheet defining an internal channel. The shaft extends through the internal channel and extends out both ends of the coiled roll pin. At each end of the shaft is disposed one or more compressible disc springs. Retaining rings or flat washers may compress the disc springs for axial restraint. The ends of the shaft may include a cover with an outer diameter larger than a joint hole. The joint compensates for vibrational loads, for example due to launch, and for dimensional changes, for example due to temperature gradients between two parts being connected by the joint. Some embodiments include no shaft, with the coiled roll pin axially secured by a cover or cover plate.

### BACKGROUND

### Field

The technology relates generally to managing thermally induced stress in a rocket, and more specifically to a pinned joint connecting a component at high temperature and another component at low temperature inside a rocket body.

### Description of Related Art

Traditionally, an orbital launch vehicle may have multiple stages such as a first stage rocket and a second stage rocket. Each rocket stage may carry liquid or solid propellant and burn the propellants in combustion chambers to generate exhaust having high thrust, to lift off and further propel the rocket. During a mission, the rocket stages reach high altitudes where ambient temperatures are extremely cold. Meanwhile, certain components related to the rocket combustion chambers and nozzles may experience high heat, such as valves and other fluid components. These extremely cold and hot conditions result in thermally induced stress and strain that can cause failures to certain components. Traditional solutions to mounting components experiencing large temperature gradients are complex and expensive to manufacture and maintain. There exists a need for improvements to mounting such components that overcome these and other drawbacks of existing solutions.

### SUMMARY

The embodiments disclosed herein each has several aspects, no single one of which is solely responsible for the disclosure’s desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing approaches to mounting components in rockets.

In one aspect, a joint for mounting a component to a bracket on a rocket body is described. The joint comprises a coiled roll pin, a shaft, one or more first disc springs, and one or more second disc springs. The coiled roll pin comprises a sheet rolled together to axially define a channel. The shaft has a first end and a second end and extends axially through the channel of the coiled roll pin. The one or more first disc springs are disposed about the first end of the shaft and are configured to axially compress. The one or more second disc springs are disposed about the second end of the shaft and are configured to axially compress.

There are various embodiments of the above and other aspects. For example, in some embodiments: the joint further comprises a first washer disposed about the first end of the shaft adjacent the one or more first disc springs; the joint further comprises a second washer disposed about the second end of the shaft adjacent the one or more second disc springs; the first end of the shaft comprises a head that flares radially outward and axially retains the shaft within the channel; the joint further comprises a nut that engages with the second end of the shaft and axially retains the shaft within the channel, where the nut seats against a shoulder on the shaft; axially outer ends of the channel have an inner width that decreases in axially outer directions; the coiled roll pin comprises a sheet of metal wrapped about a central axis at least one complete turn; the coiled roll pin is configured to provide a radially outward resilient force to the joint to compensate for radial thermal expansion of the joint; the coiled roll pin is configured to damp out vibratory loads from the rocket body; the one or more first and second disc springs are configured to limit an axially tensile force to the shaft to compensate for axial thermal expansion of the joint; the joint further comprises a lug extending from the component surrounding an axially central section of the coiled roll pin and shaft, and a clevis extending from the bracket surrounding axially outer sections of the coiled roll pin and shaft.

In another aspect, a rocket component mounting assembly comprises a component and a bracket connecting the component to a rocket body at a joint. The joint comprises a coiled roll pin, a shaft, and one or more disc springs. The coiled roll pin defines an inner channel. The shaft has a first end and a second end, where at least a portion of the shaft is disposed in the channel of the coiled roll pin, and where the first end and the second end are disposed outside the inner channel. The one or more disc springs are disposed at each of the first and second ends of the shaft and are configured to compress and expand axially in response to thermal expansion and contraction of the joint to axially retain the shaft within the channel of the coiled roll pin.

There are various embodiments of the above and other aspects. For example, in some embodiments: the component is a pressure control system component and the rocket body is a longeron; the assembly further comprises first and second washers at first and second ends respectively of the shaft and is configured to cause axial compression of the one or more disc springs at the first and second ends respectively; the first end of the shaft comprises a head configured to cause axial compression of the one or more disc springs at the first end; axially outer ends of the inner channel have an inner width that decreases in axially outer directions; and/or the coiled roll pin is rolled from a sheet of resilient rigid material.

In another aspect, a method of joining a pressure control system component to a rocket body is described. The method comprises inserting a coiled roll pin through aligned openings in the component and a bracket that is attached to the rocket body, inserting a shaft through a channel defined by the coiled roll pin, assembling one or more disc springs about first and second ends of the shaft, and axially restraining the one or more disc springs about the first and second ends.

There are various embodiments of the above and other aspects. For example, in some embodiments: the method further comprises assembling one or more washers about each of the first and second ends of the shaft; and/or the method further comprises causing axial compression of the one or more disc springs at the first end with a head of the shaft and causing axial compression of the one or more disc springs at the second end with a nut engaged with the shaft.

In another aspect, a joint for mounting a component to a bracket on a rocket body is described. The joint comprises a coiled roll pin, a first cover plate, and a second cover plate. The coiled roll pin comprises a sheet rolled together to axially define a channel and extends axially from a first end to a second end through aligned holes in the joint. The first cover plate is disposed at the first end and is configured to limit an axially outward movement of the coiled roll pin at the first end. The second cover plate is disposed at the second end and is configured to limit an axially outward movement of the coiled roll pin at the second end.

There are various embodiments of the above and other aspects. For example, in some embodiments: the joint further comprises one or more retaining rings configured to limit axial movement of the first or second cover plates; the first cover plate or the second cover plate is threaded into a cavity formed in the joint; the joint further comprises one or more covers configured to limit axial movement of the first or second cover plates; the joint further comprises one or more set screws securing the one or more covers to the joint; and/or the joint does not include a shaft extending through the channel of the coiled roll pin.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made without departing from the spirit or scope of the subject matter presented here. It will be readily understood that the aspects of the present disclosure, as generally described herein, and illustrated in the drawings, may be arranged, substituted, combined, and designed in a wide variety of different configurations, all of which are explicitly contemplated and make part of this disclosure.

FIG. 1 is a side view of an example rocket system that includes a first stage rocket, a second stage rocket, and a payload.

FIG. 2 is a perspective view of an embodiment of a joint connecting a component, such as a valve as shown, to a mounting bracket attached on a rigid structure inside the rocket system of FIG. 1.

FIG. 3 is cross-sectional view of an example embodiment of a joint, including a coiled roll pin, a shaft with a head, washers, disc springs, and a nut, to connect a clevis on a mounting bracket with a lug extended from a component, shown as a valve.

FIG. 4A is cross-sectional view of another example embodiment of a joint, including a coiled roll pin, a shaft, washers, disc springs, and retaining rings to connect a clevis on a mounting bracket with a lug extended from a manifold.

FIG. 4B is a detail view of a portion of the cross-sectional view as indicated in FIG. 4A.

FIG. 5 is a cross-sectional view of another example embodiment of a joint, including a coiled roll pin with a shaft and covers to connect a clevis on a mounting bracket with a lug extended from a component.

FIG. 6 is a cross-sectional view of one end of another example embodiment of a joint having a coiled roll pin and a shaft, showing detailed structure of the coiled roll pin and shaft and locking features including washers with retaining rings.

FIG. 7 is a perspective view of an example embodiment of a coiled roll pin that may be used with any of the joints of the preceding figures.

FIG. 8A is a perspective view of another example embodiment of a joint connecting a clevis on a mounting bracket with a lug extending from a component.

FIG. 8B is a cross-sectional view of the joint of FIG. 8A, including a coiled roll pin without a shaft, as well as covers and retaining rings, to connect a clevis on a mounting bracket with a lug extending from a component.

FIG. 8C is a detail cross-sectional view taken from FIG. 8B showing details of the first end, including the coiled roll pin, the first cover plate, and the retaining ring.

FIG. 8D is a detail cross-sectional view of another embodiment of the first end of FIG. 8B, including the coiled roll pin, a threaded cover plate, and a retaining ring.

FIG. 9A is a perspective view of another example embodiment of a joint connecting a clevis on a mounting bracket with a lug extending from a component.

FIG. 9B is a cross-sectional view of the joint of FIG. 9A, including a coiled roll pin without a shaft, as well as cover plates and threaded covers, to connect a clevis on a mounting bracket with a lug extending from a component.

### DETAILED DESCRIPTION

The following detailed description is directed to certain specific embodiments for devices, systems, and methods related to mounting joints for rocket systems. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the present disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Reference will now be made in detail to embodiments of the present disclosure, examples of which are illustrated in the accompanying drawings. Wherever possible, the same reference numbers will be used throughout the drawings to refer to the same or like parts.

It is desirable to operate reusable rockets for multiple launches and missions. For example, it is desirable that a rocket stage can be reused for more than twenty times, or even more than fifty times. As such, it is further desirable to reuse as many portions of a rocket as possible to minimize the cost of missions and to promote efficiency. Rocket assemblies often comprise different types of components, e.g., the rigid structures of a longeron for the rocket body, the rocket engines that need to stand extremely high temperatures, the tanks, pipes and turbopump valves and manifolds to store and transport fluids including liquid and gas having very high or very low temperatures, and the electronic components including wires and printed circuit boards (PCBs). The reliability of these components needs to be considered individually and systematically. One consideration is the joints for mounting high temperature components, such as valves, with low temperature rocket bodies. These joints should be simple to assemble, repair, and replace as needed for reusable rockets. Example joints with these and other advantages are described herein with respect to example rocket configurations. It is understood the joints may be used with different rocket configurations, or in other non-rocket applications where similar environmental influences may be present, such as high temperature gradients, vibratory loads, etc.

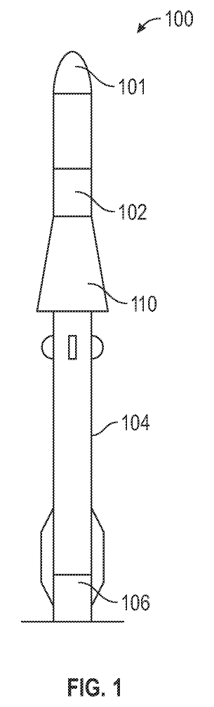

FIG. 1 shows an example embodiment of a rocket system 100 having a first stage rocket 104, a second stage rocket 102, and a payload 101. The rocket system 100 is provided to complete multiple extraplanetary or orbital missions. Therefore, at least the first stage 104 and desirably the second stage rocket 102 are reusable for multiple missions. The first stage rocket 104 shown in FIG. 1 includes a fuel tank and a plurality of rocket engines 106 configured for atmospheric launch operation to send the second stage rocket 102 and the payload 101 to the upper atmosphere. The purpose of the second stage rocket 102 is to deliver the payload 101 to a planned low earth orbit or an outer space orbit.

During a launch mission, the rocket system 100 lifts off to the upper atmosphere, and the first stage rocket 104, the second stage rocket 102 and the payload 101 are surrounded by a cryogenic environment. As such, certain structural components inside the body of the rockets, such as structural longerons, can be lowered to about -60 °F (or about -50 °C). Meanwhile, burning of propellant in a combustion chamber can cause certain components, e.g., pipes and pressure control system valves or components, to quickly heat up to about 400 °F (or about 200 °C), and may be as high as 800 °F (427 °C). The extremely low and high temperatures within the same vicinity create large temperature gradients that can cause components to thermally contract or expand, causing mechanical stress and strain. An extreme situation happens when a very cold component and a very hot component are connected together, causing a shrunken dimension to encounter an elongated dimension. This thermally induced dimensional change and stress can be exacerbated by vibration from the powerful thrust generated by the extremely high speed exhaust, and by manufacturing tolerance stack-up. For multiple launches, the type of thermally induced strain, or combined strain, and stress can cause certain components to develop fatigue failure or even sudden catastrophic failure. These connections with large temperatures gradients must therefore be carefully designed to withstand mission requirements, while providing ease of assembly and reuse, which may require replacement after a mission.

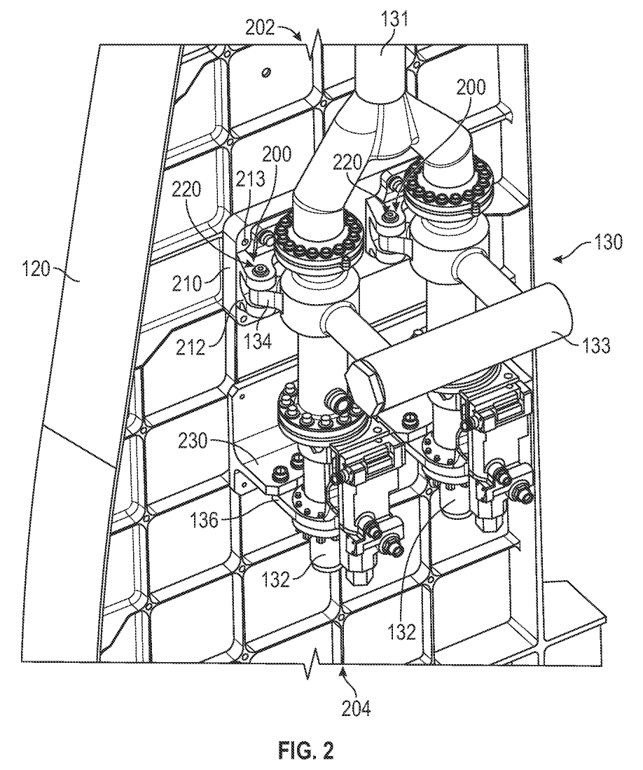

FIG. 2 is a perspective view illustrating an example fluid component system 130 such as a pressure control system joined with, e.g., mounted on, a rigid rocket structure 120, e.g., on a longeron, of a rocket such as the rocket system 100 shown in FIG. 1. The rigid rocket structure 120 may be part of the body of the first stage rocket 104, the body of the second stage rocket 102, or any part of the stage or payload 101. The fluid component system 130 has two components 132, such as valves as shown, connected together by a manifold 133 in between the components 132. The components 132 may extend upward to a manifold 131 at a front end 202 of the rigid rocket structure 120. The component system 130 can comprise a single component 132, or more than two components 132. Each of the components 132 has a lug 134 that is attached to a clevis 212 at the front end 202, forming at least one joint 200, e.g., two joints 200 as shown. Each clevis 212 may be attached to a forward mounting bracket 210 which is attached to or integral with the rigid rocket structure 120, e.g., on a longeron. In this implementation, the lug 134 can be assembled with the clevis 132, which can be performed on a bench for ease of operation. Subsequently, the clevis 132 of the clevis-and-lug assembly can be attached to the mounting bracket 210, which may be attached to the rigid rocket structure 120. In other embodiments, the clevis 212 and the mounting bracket 210 can be a single, monolithic piece, and attached to the rigid rocket structure 120.

Each joint 200 includes the clevis 212 connected to or extending from the mounting bracket 210, the forward lug 134 protruding from the component 132, and a pin assembly 220. The mounting bracket 210 may be mounted with bolts extending through holes 213 on the rigid rocket structure 120. The pin assembly 220 extends through aligned holes of the lug 134 and clevis 212 to secure the clevis 212 with the respective component 132.

During launch, the hot fluid from the engine flows through the component 132, which may form a part of a fluid pressure control system, causing the component 132 to heat to about 400 °F, or may be up to about 800 °F. Thermal expansion may cause the dimensions of the component system 130 to expand, trying to force the two components 132 farther apart from each other. Consequently, the distance between the mounted components may increase on the component-side of the joints 200. Conversely, the temperature of the rigid rocket structure 120 may decrease to about -60 °F during launch, and the distance between the two forward clevises 212 may decrease due to the temperature change. The thermally induced dimensional changes may be significant to generate enough stress to cause failures. With a temperature gradient of 460 °F, for example, a part made of metal may experience between 0.2% and 0.6% of dimension change. For example, the dimensions of a part made of titanium may change 0.22%, and a part made of aluminum may change 0.6%. On the other hand, for a part made of plastic, the dimension change within the same temperature span may be between 0.4% and 2.0%. For example, a part made of ABS/PC plus 20% glass fiber may change 0.45%, and a part made of ABS may change 1.75%. The joint 200 shown in FIG. 2 illustrates a solution to manage the thermally induced dimension changes in order to reduce the risk of failure as well as to protect the mounted components.

As a comparison to the improved structure of the joint 200, FIG. 2 also shows a conventional mounting of lower portions of the component system 130 to the rigid rocket structure 120 by aft mounting brackets 230. The mounting is by bolting each aft flange 136 extruded from the respective component 132 to the corresponding aft mounting bracket 230. This type of bolted joint is stiff and does not compensate for dimensional changes. Thermally induced dimensional changes may cause stress high enough to result in structural failure. Extreme vibration caused by powerful thrust during rocket launch can exacerbate the dimensional changes and further contribute to such failure. In some embodiments according to the present disclosure, the joints 200 may be used in place of the conventional mounting at these aft interfaces. The joints 200 can lower stiffness of the connections, e.g., by a couple orders of magnitude, and can significantly increase mechanical damping which may reduce the response to vibratory input of the rigid rocket structure 120 to the components 130.

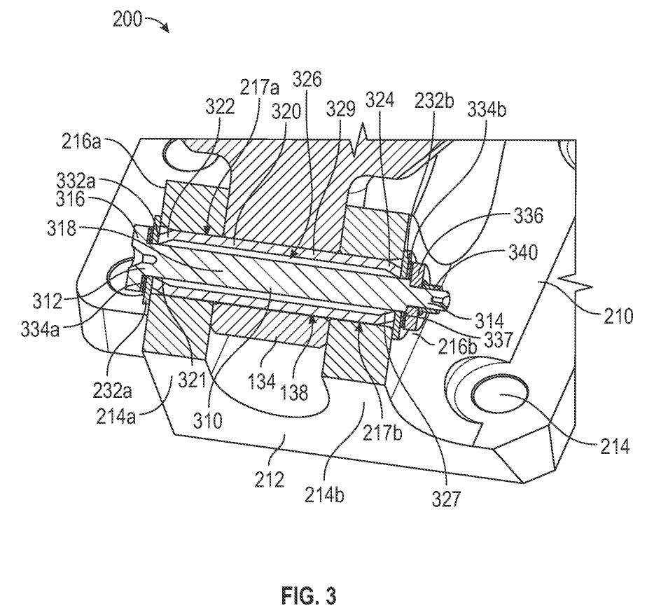

FIG. 3 illustrates a cross-sectional view of an embodiment of the joint 200. The joint 200 connects the forward lug 134 on the component 132 to the clevis 212 on the forward mounting bracket 210. The forward mounting bracket 210 is mounted on the rigid rocket structure 120, such as a longeron, as described.

The joint 200 includes a coiled roll pin 320 and a shaft 310 extending axially through an interior of the coiled roll pin 320. The coiled roll pin 320 forms an internal channel 326 extending from a first opening 321 at a first end 322 of the coiled roll pin 320 to a second opening 327 at an opposite second end 324. The coiled roll pin 320 may have a generally tubular shape formed by the rolled layers. Each of the first end 322 and the second end 324 of the coiled roll pin 320 has a reduced width, for example by crimping. The channel 326 at the first opening 321 and the second opening 327 have internal widths that are smaller than a width in the middle portion 329 of the coiled roll pin 320. The width of the channel 326 thus decreases at the first and second ends 322, 324 in radially outward directions of the channel 326. An outer width of the coiled roll pin 320 may similarly decrease at the ends 322, 324.

As further shown in FIG. 3, in the joint 200, the coiled roll pin 320 is inserted and extends through a joint hole 217a in a first clevis prong 214a, through a joint hole 138 of the component lug 134, and through a joint hole 217b in a second clevis prong 214b. A tight fit may be formed, e.g., an interference fit, between outer surfaces of the coiled roll pin 320 and inner surfaces of the aligned joint holes 217a, 138, 217b. An advantage of this configuration is minimizing tolerance stack and increasing damping to vibratory loads. When engaged, the first end 322 of the coiled roll pin 320 is flush or about flush with a first end surface 216a of the first clevis prong 214a, and the second end 324 of the coiled roll pin 320 is flush or about flush with a second end surface 216b of the second clevis prong 214b. However, the length of the coiled roll pin 320 may be shorter or longer than the distance between the first end surface 216a and the second end surface 216b, for example to compensate for dimensional changes due to thermal expansion.

The coiled roll pin 320 surrounds the shaft 310. For example, the shaft 310 extends through the channel 326 of the coiled roll pin 320. The shaft 310 extends through other components at one or both the ends of the shaft 310. The shaft 310 comprises a first end 312 that protrudes axially outward from the first end 322 of the coiled roll pin 320 on the left side in FIG. 3. Likewise, a second end 314 of the shaft 310 protrudes axially outward from the second end 324 of the coiled pin 320 on the opposite right side. When the shaft 310 is engaged with the coiled roll pin 320, a tight fit, e.g., an interference fit, may be formed at the first end 322 and at the second end 324 of the coiled roll pin 320 due to crimping at the ends of the coiled roll pin 320. Assembled together, the shaft 310 and the pin 320 may be able to stand much higher shear load as compared to each of the pin and the shaft individually. The shaft 310 and the pin 320 arrangement may be able to increase damping of the joint 200 to vibratory loads.

Further, the shaft 310 has a shaft head 316 at the first end 312 that flares radially outward and has a larger width than that of a shaft body 318, which is the main cylindrical portion of the shaft 310 extending axially between the first end 312 and the second end 314. A disc spring 334a, e.g., a spring washer, a Belleville washer, a helical lock washer, a helical spring, or the like, is included. The disc spring 334a may be conical or frustoconical in shape. The disc spring 334a may be a flat spiral spring of one or two or more turns. The disc spring 334a may not rest flush against a flat surface without the presence of a load thereon. The disc spring 334a may be elastic and configured to be compressed under an axial compressive load. The disc spring 334a may provide a spring force and absorb shock by providing an axial load that counters vibrations. A fender washer 232a is also included. The fender washer 232a may have a larger outer diameter than a flat washer having a similar-sized central hole, and thus the fender washer 232a has more bearing surface than such a flat washer. In some embodiments, the outer diameter of the fender washer 232a may be more than one and a half times, more than two times, more than two and a half times, more than three times, more than three and a half times, more than four times, or more than five times the diameter of the central hole of the fender washer 232a. The disc spring 334a and the fender washer 232a are disposed about the shaft 310 and axially restrained and compressed between the shaft head 316 and the first surface 216a of the first clevis prong 214a. The fender washer 232a is located between the first end 322 of the coiled roll pin 320 and the disc spring 334a. The disc spring 334a is located between the fender washer 232a and the shaft head 316. The shaft 310 extends through aligned respective openings in the disc spring 334a and the fender washer 232a. The fender washer 232a has a larger outer diameter than the diameter of the joint hole 217a. Due to the larger diameter, the fender washer 232a compresses axially inwardly on the first end 322 of the coiled roll pin 320, e.g., on an annular end surface 332a of the coiled roll pin 320, and/or on the first surface 216a of the first clevis prong 214a. In some embodiments, at the first end 312 of the shaft 310, there may be one, two, three, four, five, six, or more disc springs 234a, and/or one, two, three, four or more fender washers 232a.

At the second end 314 of the shaft 310, a second fender washer 232b, a second disc spring 334b, e.g., a disc spring or a helical lock washer, a second washer 336, and a nut 340 are disposed about the shaft 310. In some embodiments, the disc spring 334a or 334b may be only disposed at the first end 312 or only disposed at the second end 314 of the shaft 310. The second fender washer 232b is located between the second end 324 of the coiled roll pin 320 and the second disc spring 334b. The second disc spring 334b is located between the second fender washer 232b and the second washer 336. The second washer 336 is located between the second disc spring 334b and the nut 340. The shaft 310 extends through aligned respective openings of the second fender washer 232b, the second disc spring 334b, the washer 336, and the nut 340. The disc spring 334b is axially restrained and compressed by the fender washer 232b and the washer 336. The nut 340, which may be self-locking, is threaded on the second end 314 of the shaft 310 at a location axially outwardly from the washer 336. The nut 340 may sit on a shoulder of the shaft 310. In some embodiments, the first end 312 of the shaft 310 may be in a hexagon shape to provide anti-rotation as the nut 340 is torqued onto the second end 314 of the shaft 310. Other anti-rotation mechanisms can be implemented in place of a hexagon shaped shaft head.

When the nut 340 is tightened, it biases or moves the shaft 310 in the rightward direction resulting in compressions of the disc spring 334b at the second end 314 as well as the disc spring 334a at the first end 312 of the shaft 310. As the nut 240 is torqued, the second washer 336 may be pressed against a shoulder 337 on the shaft body 318 at the second end 314, setting the compression of the disc springs 334a, 334b, e.g., spring washers. This may also limit the shaft preload stress to the second end 314 of the shaft body 318, outside the coiled roll pin 320. In this way shear loading on the coiled roll pin 320 and the shaft 310 may not get concentrated by the presence of threads and may not be combined with the preload stresses from the nut 340. The tightening of the nut 340 may cause a relatively low tensile force to be applied to the shaft 310. The self-locking nut 340 is tightened in such a way, as limited by the shoulder 337, to exert a compression force on the disc springs 334a, 334b, but allows enough remaining compression distance for the disc springs 334a, 334b to absorb axial dimensional changes in the joint 200. This may alleviate thermal strain (or loosening) resulting from the joint 200 increasing or decreasing in temperature. For instance, without the disc springs 334a, 334b, the joint 200 may heat up and the thermal growth across the width of the clevis 212 may be more than the axial thermal growth of the shaft 310. In such case, the result will be axial thermal strain on the shaft 310 which could then combine with shear or other stresses to shorten the life of the shaft 310. The self-locking nut 340 can be threaded on using a wrench with torque controlled within a predetermined range. In some embodiments, at the second end 314 of the shaft 310, there may be two, three four or more second fender washers 232b, and/or two, three, four, five, six or more second disc springs 334b, and/or two, three, four or more washers 336, and/or two, three or more nuts 340.

Further, the second washer 336 may compress on the disc spring 334b to prevent the nut 340, that is threaded on the second end 314, from losing preload due to vibration. The nut 340 in some embodiments may be self-locking to provide robustness against loosening due to vibratory loads. The disc springs 334a, 334b may help limit thermal strain in the shaft 310 as the temperature gradient between the relatively hotter component 132 and the relatively colder mounting bracket 210 increases. The disc springs 334a, 334b and the preload are gauged so that the nut 340 and shaft head 316 do not lock up on the end surfaces 216a, 216b of the respective clevis prongs 214a, 214b. In some embodiments, the disc springs may be omitted for lower cost and easier assembly, if the structure of the shaft 310 and the coiled roll pin 320 alone are sufficiently capable of handling the thermal and vibratory loads for a particular launch environment.

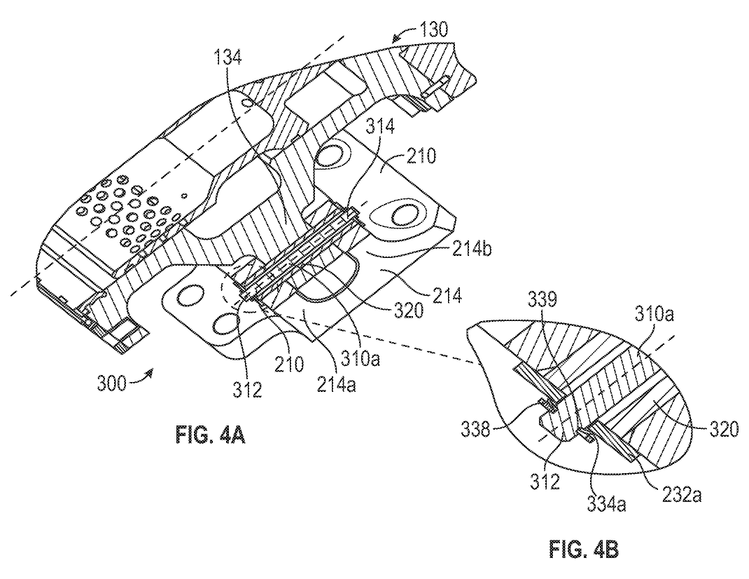

FIGS. 4A and 4B depict cross-sectional views of another embodiment of a pinned joint 300. The joint 300 may be used to attach components, such as the component 132 and the mounting bracket 210 with the clevis 212 on the rigid rocket structure 120, as described with respect to FIGS. 1 and 2. FIG. 4A is a cross-section of the overall joint 300, and FIG. 4B is a detail view of a portion thereof as indicated in FIG. 4A. The joint 300 in FIGS. 4A and 4B may have the same or similar features and/or functions as the joint 200 in FIG. 3, and vice versa, except as otherwise described.

As shown in FIGS. 4A and 4B, the joint 300 includes a coiled roll pin 320 surrounding a shaft 310a that extends from a first end 312 to a second end 314. FIG. 4B shows a cross-sectional view of the first end 312 of the shaft 310a and the surrounding structures. At the first end 312, the fender washer 232a and the disc spring 334a are disposed about the shaft 310a. The fender washer 232a and the disc spring 334a are held in place by a retaining ring 338, e.g., an E-clip retaining ring, a C-clip retaining ring, or a 360 degree retaining ring, by clipping the retaining ring 338 in an annular, recessed groove 339 at the first end 312 of the shaft 310a. The second end 314 of the shaft 310a has the same components in the same arrangement as the first end 312, including the fender washer 232a, the disc spring 334a, and the retaining ring 338.

To assemble the components and compress the disc springs 334a on both ends, the retaining ring 338 at one end (either the first end 312 or the second end 314) is clipped on first. The second retaining ring 338 at the other end is then clipped on when the disc springs 334a at both ends are compressed. For example, after clipping the first retaining ring 338 over the first disc spring 334a at the first end 312, the shaft 310a may then be biased toward the second end 314 to compress the first disc spring 334a. Then, with the second disc spring 334a and second fender washer 232a disposed about the second end 314 of the shaft 310a, the second retaining ring 338 may be placed over and onto the second end 314 to compress the second disc spring 334a and clip into a second recessed groove 339 at the second end 314. The biasing of the shaft 310 may then be released to allow the shaft 310a to move in the direction of the first end 312, and allow the compressive forces on the two disc springs 334a to reach an equilibrium and thereby stabilize the shaft 310a in the axial directions. At one or both ends 312, 314 of the shaft 310a, one or more additional washers may be disposed between the disc spring 334a and the retaining ring 338. The additional washer(s) may make assembly easier and/or improve the interface between the retaining ring 338 and the disc spring 334a by providing a full 360-degree bearing surface for the disc spring 334a.

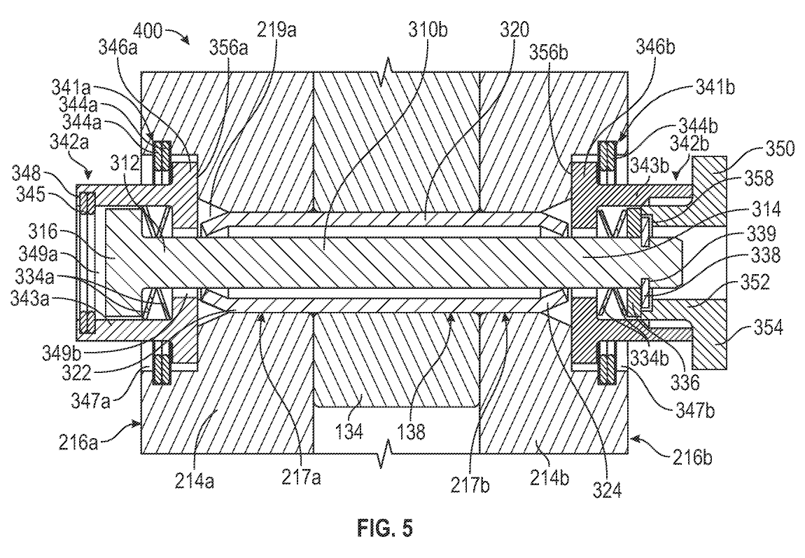

FIG. 5 shows a cross-sectional view of another embodiment of a pinned joint 400. The joint 400 may be used to attach components, such as the component 132 and the mounting bracket 210 with clevis 212 on the rigid rocket structure 120, as described with respect to FIGS. 2 and 3. The joint 400 in FIG. 5 may have the same or similar features and/or functions as the joint 200 in FIG. 3, and vice versa, except as otherwise described.

As shown in FIG. 5, the joint 400 includes the coiled roll pin 320 surrounding a shaft 310b, which are extending through respective aligned openings in the clevis prongs 214a and 214b and the lug 134. The shaft 310b includes a shaft head 316 at the first end 312 that flares radially outwardly to an outer width that is greater than an outer width of the elongated body of the shaft 310b. A first cover 342a is disposed around the shaft head 316 at the first end 312 of the shaft 310b. The first cover 342a has a tubular sidewall 343a extending to a flanged base 346a, and with first and second openings 349a and 349b at opposite ends thereof. The flanged base 346a extends radially inwardly and radially outwardly from the sidewall 343a of the first cover 342a. The flanged base 346a is radially secured by and sits within a recess 347a formed in the first end surface 216a of the first clevis prong 214a. The flanged base 346a has a larger outer diameter than the inner diameter of an opening 219a of the joint hole 217a in the first clevis prong 214a, such that the first cover 342a compresses axially inwardly on a bottom surface 356a of the recess 347a of the first clevis prong 214a.

The tubular sidewall 343a of the cover 342a surrounds and radially secures therein the shaft head 316 and one or more disc springs 334a, for example two, as shown. The disc springs 334a are compressed between, and thereby provide axially outward forces on the shaft head 316 and the flanged base 346a of the first cover 342a.

One or more retaining rings 344a, for example two as shown, are secured within an annular groove 341a formed within the recess 347a of the first clevis prong 214a. The retaining rings 344a have an inner diameter that is smaller than the outer diameter of the flanged base 346a of the first cover 342a, to thereby axially secure the cover 342a with the first clevis prong 214a and/or limit axial movement of the cover 342a in an axially outward direction from the joint 400. One or more second retaining rings 345, for example two as shown, are secured within an inner annular groove 348 near an axially outer edge of the tubular sidewall 343a inside the first opening 349a. The second retaining rings 345 have an inner diameter that is smaller than an outer diameter of the shaft head 316 of the shaft 310b, to thereby limit axial movement of the shaft 310 in an axially outward direction from the joint 400.

The second end 314 of the shaft 310b includes a second cover 342b, which may have the same features as the first cover 342a except as otherwise described. The second cover 342b compresses axially inwardly on a bottom surface 356b of a recess 347b formed in the end surface 216b of the second clevis prong 214b. The second cover 342b has a tubular sidewall 343b that radially secures therein the second end 314 of the shaft 310b and one or more disc springs 334b, for example two, as shown. One or more retaining rings 344b, for example two as shown, are secured within an annular groove 341b formed within the second clevis prong 214b. The recess 347b is formed within the end surface 216b of the second clevis prong 214b. The retaining rings 344b have inner diameters that are smaller than an outer diameter of a flanged base 346b of the second cover 342b, to thereby axially secure the second cover 342b within the recess 347b, and/or limit axial movement of the second cover 342b in an axially outward direction from the joint 400. The retaining rings 344b further axially secure the second cover 342b from sliding out of the second clevis prong 214b, e.g., prior to insertion of the shaft 310b in the joint 400, as well as after the shaft 310b is removed, for example during replacement of the shaft 310b.

The implementation of FIG. 5 may have other advantages. For example, if the shaft 310b fails, the coiled roll pin 320 may be constrained in place by the covers 342a, 342b, because the covers 342a, 342b are held in place by the retaining rings 344a, 344b respectively. In some embodiments, one or more of the covers 342a, 342b may be replaced by bolted-on cover plates. In some embodiments, the covers 342a, 342b may be threaded into the respective recess 347a, 347b. In some embodiments, the covers 342a, 342b may be kept in place by retaining rings 344a, 344b, respectively, as described above, to restrain the coiled roll pin 320 in the joint holes 217a, 138, 217b with the shaft 310b. Such implementations may have the same advantages as described above with respect to FIG. 5.

The disc springs 334b are compressed and axially retained by an adjacent washer 336, which may be flat as shown, disposed about the second end 314 of the shaft 310b. A retaining ring 338 is clipped into the recessed groove 339 formed within the second end 314.

The components disposed on the second end 314 may be secured by an end cover 350. The cover 350 includes a tubular sidewall 352 extending axially inwardly from an outer, annular flanged base 354. The sidewall 352 axially retains and transfers a compression force to the washer 336. The sidewall 352 of the cover 350 may have outer threads that engage with corresponding inner threads of the sidewall 343b of the second cover 342b, to axially retain the cover 350 and cause the compression of the disc springs 334b. As the cover 350 is tightened with the second cover 342b and moves axially inwardly toward the joint 400, the disc springs 334a at the first end 312 and the disc springs 334b at the second end 314 are compressed. The cover 350 includes a bore 358 at an axially inward end thereof that receives therein and radially surrounds the retaining ring 338 for the purpose of restraining the retaining ring 338 from expanding and dislodging from the recessed groove 339 on the second end 314 of the shaft 310b.

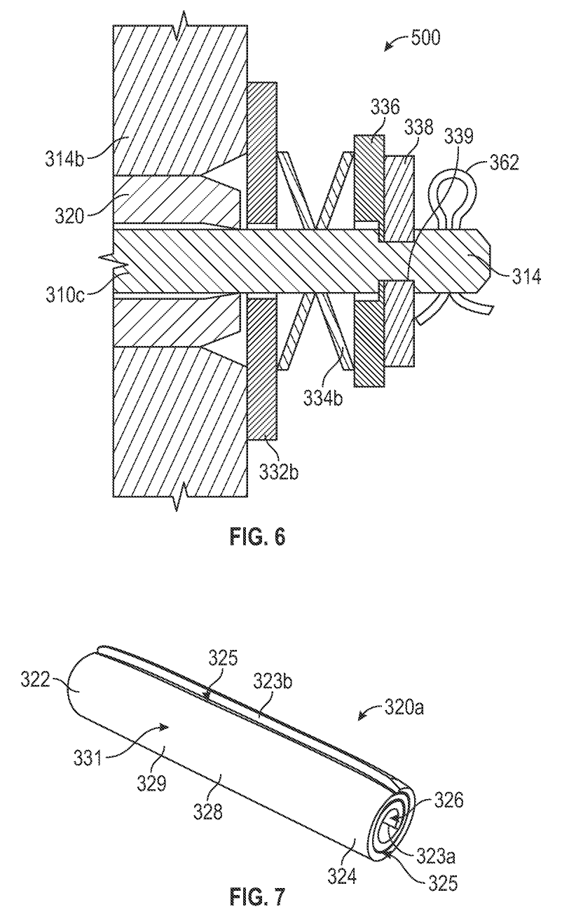

FIG. 6 shows a partial cross-sectional detail view of one end of another embodiment of a joint 500. The structure of the joint 500 in FIG. 5 may have the same or similar features and/or functions as the joint 200 in FIG. 3, and vice versa, except as otherwise described. The end of the joint 500 shown in FIG. 6 may replace the second end of the joint 200 that includes the second end 314 of the shaft 310, as shown in FIG. 3. The opposite end of the joint 500 may be the same as the first end of the joint 200 that includes the first end 312 of the shaft 310, as shown in FIG. 3.

As shown in FIG. 6, instead of having the self-locking nut 340, the joint 500 includes a retaining ring 338. The joint 500 further includes a fender washer 332b, one or more of the disc springs 334b (two as shown), and the second washer 336 disposed about the shaft 310c and axially retained by the retaining ring 338. The retaining ring 338 is clipped in an annular, recessed groove 339 formed in an outer surface of the shaft 310c. A cotter key 362 may be inserted through a hole located axially outwardly from the retaining ring 338 at the end of the shaft 310c, for enhanced robustness and reliability, for example, to prevent the second washer 336 from falling off if the retaining ring 338 detaches from the recessed groove 339.

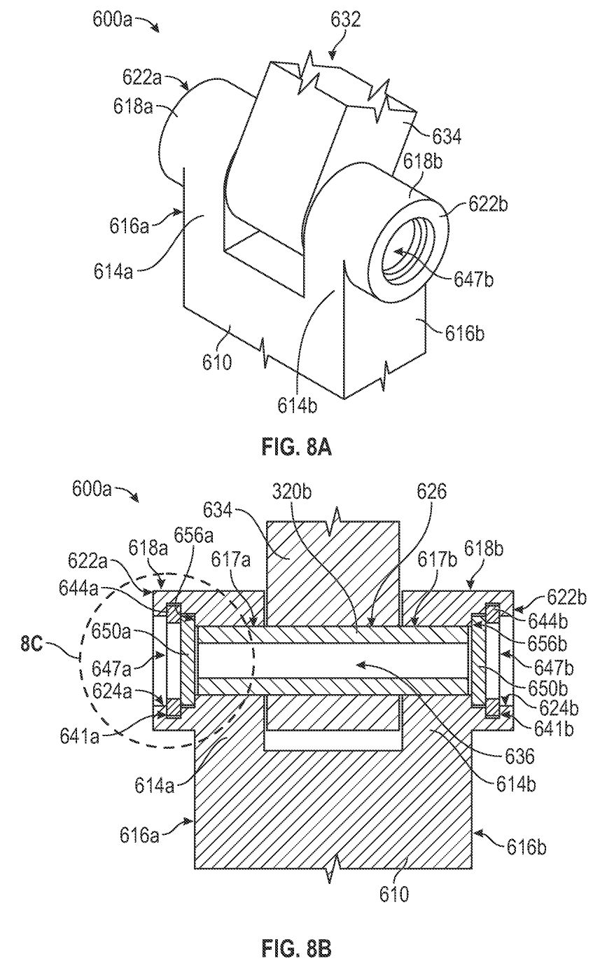

FIG. 7 is a perspective view of an embodiment of a coiled roll pin 320a. The coiled roll pin 320a may be used in any of the joints described herein, for example the joints shown in FIGS. 2-6. The coiled roll pin 320 shown and described with respect to the joints of FIGS. 2-6 may have the same or similar features and/or functions as the coiled roll pin 320a of FIG. 7, and vice versa.

As shown in FIG. 7, the coiled roll pin 320a comprises a sheet 331 that is rolled and extends from an inner edge 323a to an opposite outer edge 323b. The inner edge 323a is rolled inside the coiled roll pin 320a. The outer edge 323b is on an outer circumferential location of the coiled roll pin 320a. The coiled roll pin 320a may be formed by rolling or wrapping a rectangular-shaped flat sheet 331 around a central axis a particular number of turns from the inner edge 323a to the outer edge 323b to define a channel 326 and an outer surface 328. One turn defines an angle of 360 degrees of wrapping between the inner edge 323a and the outer edge 323b. When finished, the rolling results in a corresponding number of layers (e.g., turns) of the sheet material forming the sidewall of the coiled roll pin 320a. As shown in FIG. 7, there are about two and one quarter turns (e.g., layers) of the coiled roll pin 320a. In some embodiments, there may be one, two, three, four, five, six, seven, eight, nine, ten, or more turns, or any fractions of turns between these integer number of turns. The number of turns may depend on the thickness of the sheet material used to form the pin, the desired diameter of the channel 326, and/or the diameter of the joint holes 217a, 217b, and 138 as shown in the joints of FIGS. 3 and 5. The coiled roll pin 320a may be made of metal or a rigid material that has a resilient characteristic.

Since the coiled roll pin 320a has a rolled configuration, an inner rolled, spiral layer is in contact with an immediately adjacent outer rolled, spiral layer to facilitate contact and sliding which helps damping vibrations. However, in some embodiments, a small gap 325 may exist between adjacent layers, e.g., in a local area, as shown in FIG. 7. Since the coiled roll pin 320a is made of a resilient material, the coiled roll pin 320a may respond to stress or strain by changing one or more dimensions, e.g., an inner and/or outer diameter. When the coiled roll pin 320a is inserted into the joint hole 217a in the first clevis prong 214a, the joint hole 138 in the lug 134, and the joint hole 217b in the second clevis prong 214b (see FIG. 3), an interference fit may be formed between the coiled roll pin 320a and the aligned holes 217a, 138, 217b. The coiled roll pin 320a may expand outwardly such that the outer surface 328 of the coiled roll pin 320a contacts the inner surfaces of the aligned holes 217a, 138, 217b. In a free state, the outer diameter of the coiled roll pin 320 may be slightly larger than the inner diameter of the joint holes 217a, 138, 217b. When assembly in the joint holes 217a, 138, 217b, the coiled roll pin 320a can be compressed radially inwardly to fit into the holes 217a, 138, 217b. During a rocket launch, when thermally induced strain or vibration from the rocket body is transferred to the coiled roll pin 320a of the joint 200, momentary compression force may be exerted radially on the outer surface 328 of the coiled roll pin 320a. This compression force may cause the coiled roll pin 320a to shrink size or expand back when the force is relieved. But the dimensional change has to go through spiral movement from the outer edge 323b to the inner edge 323a or vice versa, and may be resisted by contact friction between adjacent layers between the outer edge 323b and the inner edge 323a. This inter-layer contact friction and the length of the spiral movement can significantly increase the damping effect of the coiled roll pin 320a to dimensional changes due to thermally induced train or vibratory loads.

The first end 322 and the second end 324 of the coiled roll pin 320a may have a smaller outer width as compared to portions of the coiled roll pin 320a located axially inwardly of the first and second ends 322, 324, e.g., at a middle portion 329. The smaller end 322, 324 may facilitate leading the insertion of the coiled roll pin 320 into the joint holes 217a, 138, 217b. The channel 326 at the first and second ends 322, 324 may also have a smaller inner diameter as compared to the inner diameter along axially inward portions of the channel 326, for example at the middle portion 329. For example, as shown in FIG. 3, a first opening 321 at the first end 322 of the coiled roll pin 320 and a second opening 327 at the second end 324 of the coiled roll pin 320 each has a smaller inner diameter than that of a middle section of the channel 326 located between the first and second ends 322, 324. As shown in FIG. 7, the coiled roll pin 320a may have a near cylindrical shape along inner and outer surfaces of axially inward or central portions of the coiled roll pin 320a, such as at the middle portion 329, and have a radially inwardly tapered section at the first and second ends 322, 324. The internal channel 326 of the coiled roll pin 320 or 320a may be slightly larger than the shaft 310 at the first and second ends 322, 324 to facilitate assembly of the shaft 310 slip fitting into the internal channel 326. However, when the coiled roll pin 320 or 320a is inserted into the joint holes 217a, 138, 217b (together with the shaft 310), the interference fit between the coiled roll pin 320 or 320a and joint holes 217a, 138, 217b may cause the coiled roll pin 320 or 320a to slightly shrink its diameter, causing a tight or tighter fit between the inner channel 326 of the coiled roll pin 320 or 320a at the ends 322, 324 and the shaft 310. An outer diameter of the central section of the shaft 310 may remain slightly smaller than the inner diameter of the center section of the coiled roll pin 320 or 320a. The tight fit of the coiled roll pin 320 or 320a to the outside joint holes 217a, 138, 217b and the internal shaft 310 provides the joint 200 or 400 with a relatively rigid connection. Further, the tight fit between the joint holes 217a, 138, 217b and the coiled roll pin 320 or 320a, and thus with the shaft 310, may increase surface contact between the components as loads in the radial planes pass through the joint 200 or 400. By such surfaces contacting each other, the strength of joint 200 or 400 and the damping of strain and vibratory loads are significantly increased. The resilient characteristic of the coiled roll pin 320 or 320a provides the capability to compensate for dimensional changes in the radial plane, whether the dimension change is caused by temperature change, by vibration, or by other factors. The coiled roll pin 320a is able to compensate for axial dimension change, as described with respect to the coiled roll pin 320 of FIG. 3. Further, the structure of the joint 200 with the lug 134 and the clevis prongs 214a, 214b lowers the axial stiffness.

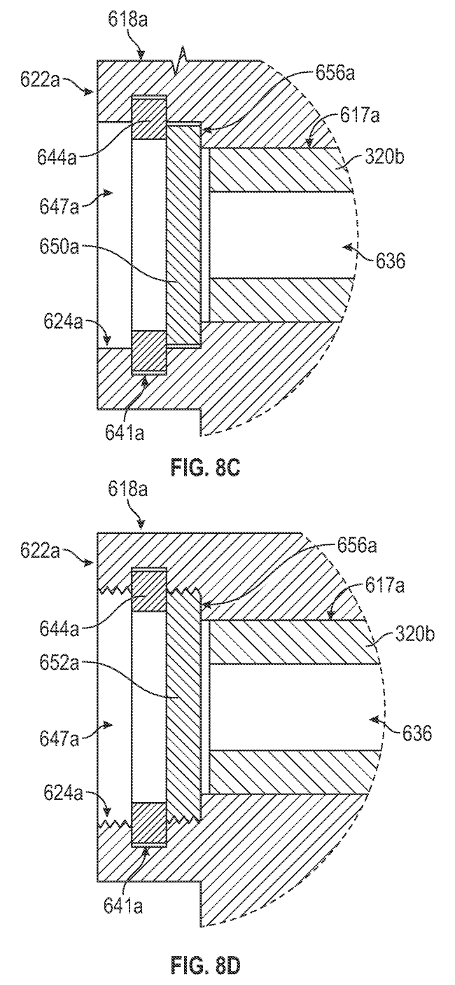

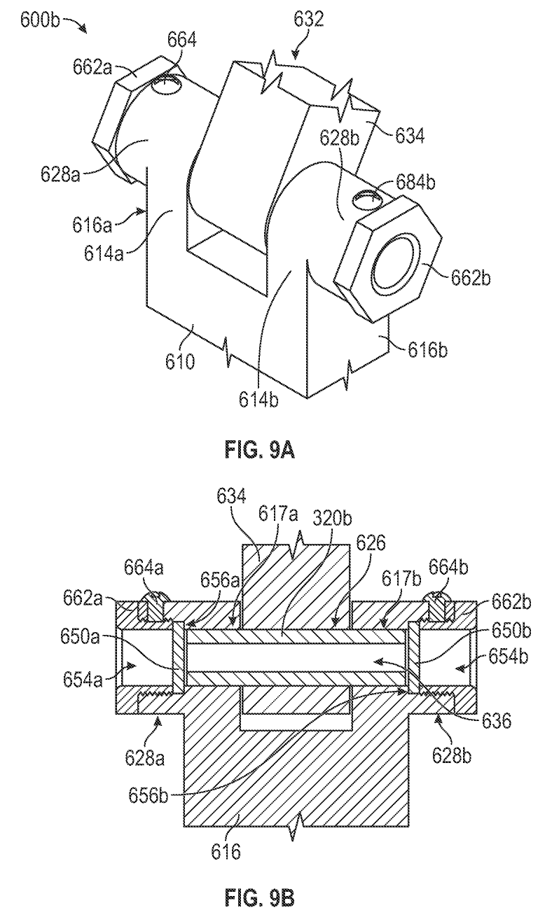

FIGS. 8A-9B illustrate various example joint embodiments, each of which has a coiled roll pin, such as the coiled roll pin 320a described above, but without a shaft, to connect a fluid component to a bracket attached to a rocket body. Any of the features described with respect to the joints and components thereof of FIGS. 2-7 may be used for the joints of FIGS. 8A-9B and vice versa, except as otherwise described. For example, the joints of FIGS. 8A-9B may be used to connect the brackets and components as described herein with respect to FIGS. 1 and 2.

FIG. 8A illustrates a perspective view of a joint 600a coupling a clevis 610 to a fluid component 632 (partially shown). The clevis 610 has first and second prongs 614a, 614b coupled to a lug 634 of the fluid component 632. The clevis 610 may be further attached to or extending from a bracket attached to the rocket body. Each of the first and second clevis prongs 614a, 614b has a first and second protruded portion 618a, 618b respectively. Each of the first and second protruded portions 618a, 618b extends from a first end surface 616a of the first prong 614a and a second end surface 616b of the second prong 614b respectively. In some embodiments, an end surface 622a, 622b of each protruded portion 618a, 618b can be flush with the respective first or second end surface 616a, 616b.

FIG. 8B is a cross-sectional view of the joint 600a, revealing internal structures of the joint. As shown in FIG. 8B, the joint 600a includes a coiled roll pin 320b extending through respective aligned openings 617a, 626, 617b formed in the first protruded portion 618a, the lug 634, and the second protruded portion 618b respectively. The coiled roll pin 320b may be any of the coiled roll pins described herein. Furthermore, the joint 600a does not include a shaft within the coiled roll pin 320b. The joint 600a may therefore be a “shaftless” joint. In some embodiments, the openings 617a, 626, 617b and an internal channel 636 of the coiled roll pin 320b may have circular cross-sectional shapes.

FIG. 8C shows a detail view of the internal structure of the protruded portion 618a. The first protruded portion 618a has a cavity 647a formed therein. The cavity 647a is open to the end surface 622a and has an annular edge 656a disposed axially inwardly from the end surface 622a and facing axially outwardly. The cavity 647a is open to the first opening 617a formed in the first protruded portion 618a. A first cover plate 650a is disposed inside the cavity 647a against the annular edge 656a at the inward side of the cavity 647a and is axially secured by a retaining ring 644a at the axially outer side of the cavity 647a toward the end surface 622a. The retaining ring 644a is clipped into an annular groove 641a, which is formed in a sidewall 624a of the cavity 647a.

The second protruded portion 618b at the right side of the joint 600a (as oriented in the figure) has a similar or the same internal structure as the first protruded portion 618a. As shown in FIG. 8B, a cavity 647b is formed in the end surface 622b. A second cover plate 650b is disposed inside the cavity 647b against an annular edge 656b at the inward side and is restricted by a retaining ring 644b at the outward side. The retaining ring 644b is clipped into an annular groove 641b formed in a sidewall 624b of the cavity 647b. The cavity 647b is open to the second opening 617b formed in the second protruded portion 618b.

To assemble the joint 600a, first the clevis 610 having the first and second prongs 614a, 614b and the component 632 having the lug 634 are disposed together, for example with an assembly tool, to align the first opening 617a in the first prong 614a, the opening 626 in the lug 634, and the second opening 617b in the second prong 614b. Then the coiled roll pin 320b is inserted into the aligned openings 617a, 626, 617b. Next, the first and second cover plates 650a, 650b are placed in the respective cavities 647a, 647b and against the respective annular edges 656a, 656b. Subsequently the retaining rings 644a, 644b are clipped into the grooves 641a, 641b respectively. In some embodiments, the assembly may be constructed in a different order. For example, the cover plate and retaining ring at one end may be inserted first, and then the coiled roll pin 320b may be inserted, etc. Further, in some embodiments, the joint 600a may include one or more disc springs and/or more than one cover plate or retaining ring in each of the cavities 647a, 647b, for example, as described with respect to FIGS. 3 and 5.

As shown in FIGS. 8B and 8C, the first and second cover plates 650a, 650b limit the movement of the coiled roll pin 320b in the axial direction, and as such ensures the integrity of the joint 600a. In some embodiments, each of the cover plates 650a, 650b can have an opening at the center, as long as the diameter of the opening is smaller than a diameter of the openings 617a or 617b. In some embodiments, instead of using a retaining ring placed in an annular groove, the first or second cover plate 650a, 650b can be kept in place axially by other means, for example, by a pin through the respective sidewall 624a, 624b of the respective cavity 647a, 647b, or via threads as described with respect to FIG. 8D, or by other suitable means.

FIG. 8D is a detail cross-sectional view illustrating another example embodiment of the internal structure of the first protruded portion 618a to restrict the axial movement of the coiled roll pin 320b. The components of the joint shown in FIG. 8D may be the same as the joint 600a of FIG. 8A, except as otherwise described. As shown in FIG. 8D, the sidewall 624a of the cavity 647a comprises an internal thread, and a cover plate 652a has a corresponding external thread formed on an outer edge thereof. The cavity 647a and the cover plate 652a therefore have circular shapes. The cover plate 652a is threaded into the cavity 647a, for example, by a screw driver, socket, or a matching torque wrench, until stopped by the annular edge 656a. The cover plate 652a can be further constrained in place, for example, by the retaining ring 644a clipped into the annular groove 641a. Such an implementation of the retaining ring 644a has the advantage of preventing the unintended axial movement of the cover plate 652a due to vibratory load from the rocket engine during launch. Other means to restrain the cover plate 652a may include a pin through the sidewall 624a, or thread-locking adhesive applied on the internal thread of the sidewall 624a or the external thread of cover plate 652a.

The coiled roll pin 320b may have the same or similar structure as the coiled roll pin 320a of FIG. 7. For example, the coiled roll pin 320b may be formed by rolling or wrapping a rectangular-shaped flat sheet, that is made of a resilient material, around a central axis a particular number of turns from an inner edge 323a to the outer edge 323b to form the internal channel 636 and an outer circumferential surface. When inserted into the aligned openings 617a, 626, 617b of the joint 600a, a tight fit (e.g., interference fit) may be formed between the outer circumferential surface of the coiled roll pin 320b and the openings 617a, 626, 617b. The spiral configuration of the coiled roll pin 320b may have the advantage of compensating for dimensional changes from thermal stress or damping out dimensional changes due to vibration. Since the joint 600a does not include a shaft, the internal channel 636 of the coiled roll pin is not limited by such a shaft. The change of dimension at the outer circumferential surface may be more easily transferred radially inwardly through the wrapped layers of the coiled roll pin 320b. As such the joint 600a without a shaft may be able to compensate for and damp out dimensional changes in the radial direction more than the implementation of the joint 200 of FIG. 3, the joint 300 in FIGS. 4A-4B, and the joint 400 in FIG. 5.

FIGS. 9A and 9B illustrate another example embodiment of a shaftless joint 600b. FIG. 9A shows a perspective view of the joint 600b that may have the same structure as the joint 600a of FIGS. 8A-8B, except for different first and second protruded portions 628a, 628b and/or components therein. For example, the joint 600b couples a clevis 610 having first and second prongs 614a, 614b to a lug 634 of a fluid component 632 (not shown).

FIG. 9B is a cross-sectional view of the joint 600b illustrated in FIG. 9A. As shown in FIG. 9B, the joint 600b includes a coiled roll pin 320b extending through aligned openings 617a, 626, 617b formed respectively in the first protruded portion 628a, the lug 634, and the second protruded portion 628b. The joint 600b does not include a shaft within the coiled roll pin 320b.

As further shown in FIG. 9B, a threaded cover 662a is threaded into a cavity formed in an axial direction in the first protruded portion 628a. The threaded cover 662a has a hexagon shaped head configured to be driven by a hexagon wrench. The hexagon shaped head flares outwardly covering an end surface of the first protruded portion 628a. In some embodiments, the head of the threaded cover 662a may have a different configuration, for example, a different size or shape or to fit a different driving tool (e.g., screw driver). The head may be other polygonal shapes, e.g. four-sided, five-sided, or rounded, etc.

The threaded cover 662a has an opening 654a extending therethrough. In some embodiments, the threaded cover 662a is a solid piece without the opening 654a. A cover plate 650a is disposed between the threaded cover 662a and a left end of the coiled roll pin 320b (as oriented in the figure). The cover plate 650a is kept in place by the threaded cover 662a to constrain the movement of the coiled roll pin 320b in the axial direction. The threaded cover 662a may be torqued by a driving tool until it presses the cover plate 650a against an annular 656a.

In some embodiments, the threaded cover 662a is further secured in place by a set screw 664a extending through a sidewall of the protruded portion 628a. When the set screw 664a is tightened, the threaded cover 662a is prevented from being unscrewed due to vibration loads. In some embodiments, the threaded cover 628a can be secured in place by other means, for example, by thread-locking adhesive, or a pin or cotter key through the sidewall of the first protruded portion 628a and at least partially through a sidewall of the threaded cover 662a.

The second protruded portion 628b at the right end of the joint 600b (as oriented in the figure) may have the same or similar internal structure as the first protruded portion 628a. As shown in FIG. 9B, the second protruded portion 628b includes a cover plate 650b in a cavity of the second protruded portion 628b to keep the coiled rolled pin 320b from axially moving outwardly. A threaded cover 662b is threaded into the cavity to keep the cover plate 650b in place. The threaded cover 662b is further secured by a set screw 664b that is driven through a sidewall of the second protruded portion 628b. In some embodiments, the cover plates 650a and/or 650b can be omitted. In such an implementation, the threaded cover, e.g., the threaded cover 662a, is dimensioned to be pressed against the annular edge 656a, and the opening 654a is constructed smaller than a diameter of the opening 617a.

As described above with respect to FIGS. 8A-8D, the joint 600b of FIGS. 9A and 9B without a shaft has the advantage of compensating for or damping out dimensional changes in the radial direction of the coiled roll pin 320b due to thermal stress and vibratory loads during a launch mission.

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described as such. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A joint for mounting a component to a bracket on a rocket body, the joint comprising:
a coiled roll pin comprising a sheet rolled together to axially define a channel;
a shaft having a first end and a second end and extending axially through the channel of the coiled roll pin;
one or more first disc springs disposed about the first end of the shaft and configured to axially compress; and
one or more second disc springs disposed about the second end of the shaft and configured to axially compress.

2. The joint of claim 1 further comprising a first washer disposed about the first end of the shaft adjacent the one or more first disc springs.

3. The joint of claim 1 further comprising a second washer disposed about the second end of the shaft adjacent the one or more second disc springs.

4. The joint of claim 1, wherein the first end of the shaft comprises a head that flares radially outward and axially retains the shaft within the channel.

5. The joint of claim 1 further comprising a nut that engages with the second end of the shaft and axially retains the shaft within the channel, wherein the nut seats against a shoulder on the shaft.

6. The joint of claim 1, wherein axially outer ends of the channel have an inner width that decreases in axially outer directions.

7. The joint of claim 1, wherein the coiled roll pin comprises a sheet of metal wrapped about a central axis at least one complete turn.

8. The joint of claim 1, wherein the coiled roll pin is configured to provide a radially outward resilient force to the joint to compensate for radial thermal expansion of the joint.

9. The joint of claim 1, wherein the coiled roll pin is configured to damp out vibratory loads from the rocket body.

10. The joint of claim 1, wherein the one or more first and second disc springs are configured to limit an axially tensile force to the shaft to compensate for axial thermal expansion of the joint.

11. The joint of claim 1 further comprising:
a lug extending from the component surrounding an axially central section of the coiled roll pin and shaft; and
a clevis extending from the bracket surrounding axially outer sections of the coiled roll pin and shaft.

12. A rocket component mounting assembly comprising:
a component; and
a bracket connecting the component to a rocket body at a joint, wherein the joint comprises:
a coiled roll pin defining an inner channel;
a shaft having a first end and a second end, wherein at least a portion of the shaft is disposed in the channel of the coiled roll pin, and wherein the first end and the second end are disposed outside the inner channel; and
one or more disc springs disposed at each of the first and second ends of the shaft and configured to compress and expand axially in response to thermal expansion and contraction of the joint to axially retain the shaft within the channel of the coiled roll pin.

13. The assembly of claim 12, wherein the component is a pressure control system component and the rocket body is a longeron.

14. The assembly of claim 12 further comprising first and second washers at first and second ends respectively of the shaft and configured to cause axial compression of the one or more disc springs at the first and second ends respectively.

15. The assembly of claim 12, wherein the first end of the shaft comprises a head configured to cause axial compression of the one or more disc springs at the first end.

16. The assembly of claim 12, wherein axially outer ends of the inner channel have an inner width that decreases in axially outer directions.

17. The assembly of claim 12, wherein the coiled roll pin is rolled from a sheet of resilient rigid material.

18. A method of joining a pressure control system component to a rocket body comprising:
inserting a coiled roll pin through aligned openings in the component and a bracket that is attached to the rocket body;
inserting a shaft through a channel defined by the coiled roll pin;
assembling one or more disc springs about first and second ends of the shaft; and
axially restraining the one or more disc springs about the first and second ends.

19. The method of claim 18 further comprising assembling one or more washers about each of the first and second ends of the shaft.

20. The method of claim 18 further comprising causing axial compression of the one or more disc springs at the first end with a head of the shaft and causing axial compression of the one or more disc springs at the second end with a nut engaged with the shaft.
